(19) United States
(12) Patent Application Publication
(10) Pub. No.: US 2008/0227923 A1
(43) Pub. Date: Sep. 18, 2008

(54) PROCESS FOR THE TREATMENT OF SiC-BONDED POLYETHERSILOXANES

(75) Inventors: Klaus-Deiter Klein, Muelheim (DE); Thomas Neumann, Bochum (DE)

Correspondence Address: FROMMER LAWRENCE & HAUG, 745 FIFTH AVENUE- 10TH FL., NEW YORK, NY, 10151, US

(73) Assignee: Goldschmidt GmbH, Essen (DE)

(21) Appl. No.: 11/755,441

(22) Filed: May 30, 2007

(30) Foreign Application Priority Data
Mar. 14, 2007 (DE) 10 2007 012 241.3

(51) Int. Cl. C08F 8/04

(52) U.S. Cl. 525/339; 525/338

(57) ABSTRACT

The invention relates to a process for the treatment of polyoxyalkylene-polysiloxane block copolymers or alkylpolysiloxane-polyoxyalkylenepolysiloxane block copolymers in which the polysiloxane blocks are bonded to the polyether blocks or alkyl radicals by SiC bonds, wherein the polyoxyalkylene-polysiloxane block copolymers or alkylpolysiloxane-polyoxyalkylenepolysiloxane block copolymers or the solutions thereof are treated with flowing hydrogen gas and optionally a further inert gas in the presence of a combination of hydrogenation catalysts known per se and acid-activated carrier materials and water at temperatures of from 20 to 200° C. and atmospheric pressure over a period of from 0.5 to 10 hours.

This application claims benefit under 35 U.S.C. 119(a) of German patent application DE 10 2007 012 241.3, filed on 14 Mar. 2007.

Any foregoing applications, including DE 10 2007 012 241.3, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

Citation or identification of any document in this application is not an admission that such document is available as prior art to the present invention.

The invention relates to a process for the treatment of polyalkylene-polysiloxane block copolymers or alkylpolysiloxane-polyoxyalkylenepolysiloxane block copolymers, in which the polysiloxane blocks are bonded to the polyether blocks by SiC bonds, wherein the compounds or the solutions thereof are treated with flowing hydrogen gas in the presence of a combination of noble metal catalysts and acid-activated carrier materials.

Polyoxyalkylene-polysiloxane block copolymers or alkylpolysiloxane-polyoxyalkylenepolysiloxane block copolymers in which the polysiloxane blocks are bonded to the polyether blocks by SiC bonds are preferably used as stabilizers in the preparation of polyurethane foams, as emulsifiers, as release agents and as active substances in cosmetic products.

They are generally prepared industrially by an addition reaction of alkenepolyethers, in particular allylpolyethers, with hydrogensiloxanes in the presence of platinum catalysts. They may correspond, for example, to the following general formula

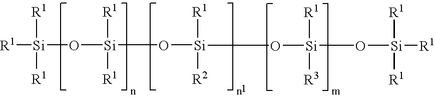

in which the substitutents and indices have the following meaning:
R¹=alkyl radical, preferably methyl radical and/or aromatic radical and/or R³,
R²=alkyl radical having 2 to 20 carbon atoms,
R³=—(CH₂)₃—O—(C₂H₄O)ₓ—(C₃H₆O)_{y}—R⁴,
R⁴=hydrogen or alkyl radical having 1 to 4 carbon atoms,
n=from 0 to 150, preferably from 1 to 120,
n¹=from 0 to 50, preferably from 0 to 40,
m=from 0 to 50, preferably from 1 to 40,
x=from 1 to 30, preferably from 1 to 25,
y=from 0 to 30, preferably from 0 to 25,
   with the proviso that at least one radical has the meaning R³ in the molecule.

In the general formula, the increments [ ]ₙ, [ ]ₙ¹, [ ]ₘ may be present in random distribution or arranged blockwise.

As a rule, a stoichiometric excess of up to 40% of allylpolyethers is used in the preparation process in order to ensure that the SiH groups are completely converted. Under the conditions of the addition reaction, a part of the allylpolyether is rearranged to give the propenylpolyethers which are not capable of undergoing an addition reaction. Polyoxyalkylene-polysiloxane block copolymers or alkylpolysiloxane-polyoxyalkylenepolysiloxane block copolymers of the type mentioned above therefore generally contain proportions of unconverted allylpolyethers and propenylpolyethers.

The reaction mixture has a more or less pronounced unpleasant, pungent odor which frequently becomes stronger on storage. This odor is troublesome when the block copolymers are used and in particular when they are used as active substances in cosmetic products or foams/shaped foam articles for interior use.

Attempts have already been made to remove the odor-forming components by blowing out with inert gas or by steam treatment. However, it has been found that the odor arises again after storage of the block copolymers or after incorporation into cosmetic formulations.

EP-A-0 398 684 (U.S. Pat. No. 5,118,754) is concerned with the removal of these odor components. This European Patent application relates to a purified polyethersiloxane which has been treated in a closed system for a period of 24 hours with aqueous 10⁻⁴ N hydrochloric acid in an amount of up to 1000 ppm, based on polyether, at 60° C. The product purified in this manner is then treated with steam under reduced pressure in order to remove the aldehydes and ketones formed during the acid treatment.

However, the fact that about 1.5 times the weight of steam, based on the weight of the polyethersiloxane treated, is required for removing the aldehydes and ketones formed was found to be disadvantageous. Considerable amounts of foul-smelling, acidic condensate which is difficult to dispose of are therefore obtained.

A further disadvantage of the acid treatment is that, if the polyethersiloxane still contains residual SiH groups, the formation of gel particles is frequently observed. These gel particles can be removed only with difficulty by filtration.

A further process for deodorizing polyoxyalkylene-polysiloxane block copolymers is described in U.S. Pat. No. 4,515,979. According to this process, phytic acid is added to the block copolymer during or after its preparation. Phytic acid is a hexaphosphate ester of myoinositol of the general formula C₆H₁₈O₂₄P₆. This compound is a naturally occurring and non-toxic natural product which occurs in grain and seeds. Not least because of its high price, this product is unsuitable for industrial use.

EP-B-0 513 645 (U.S. Pat. No. 5,225,509) describes a process for deodorizing polyoxyalkylene-polysiloxane block copolymers in which the polysiloxane blocks are bonded to the polyether blocks by SiC bonds, wherein hydrogen is allowed to act on the block copolymers in the presence of hydrogenation catalysts known per se, optionally with the concomitant use of from 0.1 to 1% by weight of an acidic alumina and from 0.1 to 1% by weight of water at temperatures of from 20 to 200° C. and a pressure of from 1 to 100 bar over a period of from 0.5 to 10 hours.

This process is carried out in closed pressure reactors, so-called autoclaves. Here, hydrogen consumed is replaced only to the extent required to reach the specified pressure again.

Processes carried out on the laboratory scale solve the problem of deodorization, and the product remains clear and free of turbidity or sediment even over a period suitable in practice.

In the procedure on an industrial scale, however, it was found that turbidity, including sediment formation and the yellow coloration, can occur in the case of products prepared by this described process after a certain storage time at room temperature, but in particular at temperatures below this. These changes can be correlated with an increase in the propionaldehyde content.

It was therefore an object of the present invention to develop a process which permits the preparation of colorless and turbidity-free polyoxyalkylene-polysiloxane block copolymers or alkylpolysiloxane-polyoxyalkylenepolysiloxane block copolymers on an industrial scale, i.e. in the region of a·10², preferably >a·10³ kg, where a is ≧1, preferably ≧3 to 10.

According to the present invention this is possible if the polyoxyalkylene-polysiloxane block copolymers or alkylpolysiloxane-polyoxyalkylenepolysiloxane block copolymers or the solutions thereof are treated with flowing hydrogen gas and optionally a further inert gas in the presence of a combination of hydrogenation catalysts known per se and acid-activated carrier materials at temperatures of from 20 to 200° C. and under ≦atmospheric pressure over a period of from 0.5 to 10 hours. Preferably, the hydrogen is allowed to act on the block copolymers at temperatures of from 110 to 140° C.

According to the invention, atmospheric pressure is understood as meaning the air pressure prevailing on site. For process engineering reasons, it is also possible to use pressure below this pressure.

According to the invention, working under standard conditions of temperature and pressure (also referred to as STP) means in the range of from 800 mbar to 1016 mbar, preferably in the range of from 900 mbar to 1016 mbar.

The reaction can, if desired or if required for technical reasons, also be carried out at even lower pressure without adversely affecting the product properties.

Customary hydrogenation catalysts known from the prior art may be used as catalysts. Nickel, copper, chromium or the metals of the platinum group are particularly suitable. The catalysts can be deposited on a suitable support. Nickel catalysts are particularly preferred owing to their relatively low price, their high reactivity and their long lives.

In general, the catalysts are used in an amount of from 0.00001 to 1% by weight of metal, based on polyethersiloxane.

Acid-activated carrier materials which may be used are synthetic or natural substances, provided that they do not result in any undesired secondary reactions in the reaction media. These may be one or more materials selected from the group consisting of active carbons, kieselguhr, diatomaceous earth, silica gel, bentonites, aluminosilicates, bleaching earths, aluminas, clays, montmorillonites, montmorillonites activated by an acid treatment, (e.g. the so-called K catalysts from Süd-Chemie) and polymeric resins, such as the acidic ion exchangers, in particular zeolites.

The amounts of acid-treated carrier materials are in the range of from 0.01 to 0.1% by weight, preferably from 0.025 to 0.08% by weight and particularly preferably from 0.04 to 0.06% by weight, based on polyethersiloxane. For reasons of process economy, it is advantageous to determine the smallest possible amount in each case on the basis of a few exploratory experiments.

The hydrogen and the optionally concomitantly used inert gas are passed in rapidly but without elevated pressure via a dip tube whose end, for example, is perforated, or ends in a frit, via a bottom nozzle or via a nozzle system according to the prior art.

The flow rates are in general in the range of from about 5000 l to about 15 0001 of gas/h, based on reactor sizes of 5±2 m³, with a hydrogen fraction of, preferably, from about 20 to 40% by volume.

The concomitantly used amount of water is in the range of from 0.1 to 5% by weight, preferably in the range of from 0.1 to 3% by weight and particularly preferably in the range of from 0.1 to 2% by weight, based on polyethersiloxane.

In a preferred embodiment of the process according to the invention, an acidic clay is used and additionally water in amounts of from 0.1 to 2% by weight or an aqueous buffer solution having a pH of from 3 to 6.

The acidic clay used may be, for example, calcium bentonites activated with acid or acid-activated bleaching earth. Buffer solutions which may be used are aqueous solutions of inorganic and/or organic acids and salts which have a pH of from 3 to 6, such as, for example, a citric acid/phosphate buffer or a citrate buffer according to Sorensen.

The inert gas, according to the invention preferably nitrogen, can be passed in before, after or simultaneously with the hydrogen treatment. According to the invention, stepwise or simultaneous introduction is preferred. In the case of small proportions of hydrogen in the gas mixture, the duration of treatment should be determined by exploratory preliminary experiments and appropriately adapted.

It is also possible, but not absolutely essential, to include the process steps for coarse purification, known from the prior art, before the actual treatment with flowing hydrogen which is essential to the invention.

After the hydrogen has acted on the polyoxyalkylene-polysiloxane block copolymers or alkylpolysiloxane-polyoxyalkylenepolysiloxane block copolymers, the catalysts can be separated from the polyoxyalkylene-polysiloxane block copolymers or alkylpolysiloxane-polyoxyalkylenepolysiloxane block copolymers in a suitable manner, for example by filtration or centrifuging.

Since the polyoxyalkylene-polysiloxane block copolymers or alkylpolysiloxane-polyoxyalkylenepolysiloxane block copolymers are frequently products with a relatively high viscosity, it may be expedient to carry out the hydrogenation of the block copolymers in the presence of suitable solvents.

The polyoxyalkylene-polysiloxane block copolymers or alkylpolysiloxane-polyoxyalkylenepolysiloxane block copolymers prepared on an industrial scale and treated according to the invention are free of troublesome odors and remain free of the unpleasant and troublesome odors known from the prior art on storage at elevated or low temperatures or after incorporation into cosmetic formulations.

A particular advantage of the process according to the invention is that the treated polyoxyalkylene-polysiloxane block copolymers or alkylpolysiloxane-polyoxyalkylenepolysiloxane block copolymers and their solutions have no discolorations, turbidity or sediments after storage in a broad temperature range.

The invention is further described by the following non-limiting examples which further illustrate the invention, and are not intended, nor should they be interpreted to, limit the scope of the invention.

The Tonsil® described in the examples and obtainable from Süd-Chemie is characterized as follows:

Tonsil CO 614 G comprises highly active acidic clay granules having a broad range of uses. It is prepared by acid-activation of calcium bentonite.

Tonsil CO 614 G comprises granules having a highly porous internal structure and a multiplicity of active centers.

Preparation of an Alkylsiloxane-Polyethersiloxane Copolymer (Example 5 from EP-B-1 520 870)

In an argon-blanketed multi-neck flask equipped with KPG stirrer, dropping funnel and reflux condenser, 0.18 ml of the catalyst solution (12 ppm of Pt) described in EP-B-1 520 870 (U.S. Pat. No. 7,157,541) is added at 25° C. to 60 g of a siloxane carrying SiH side groups and having an average composition MD₇₅(DH)₂₅M (SiH content: 3.6 eq/kg). 21 g of hexadecene are added dropwise in the course of 18 minutes so that the heat of reaction causes the batch temperature to increase to 64° C. 35.6 g of a polyether having an average composition CH₂═CH—CH₂O—(C₂H₄O)₈—OH (Iodine number: 62 g iodine/100 g) are then rapidly added dropwise in the course of 10 minutes, the reaction temperature decreasing to 50° C. After the end of the addition, a further 10.9 g of hexadecene are added in the course of 10 minutes. Gas volumetric SiH determination on a sample of the cooled reaction batch shows quantitative conversion.

### EXAMPLE 1

Deodorization with Hydrogen and Nitrogen

At about 90° C., 1.8 kg of palladium on carbon, 1.4 kg of Tonsil® (Süd-Chemie AG) and 30 kg of water are added to 2900 kg of an alkylsiloxane-polyethersiloxane copolymer, prepared analogously to example 5 from EP-B-1 520 870. Thereafter, heating to 120° C. is effected and about 11 000 l of hydrogen/h are fed in via an immersed tube, the procedure being effected at close to atmospheric pressure, i.e. in a range of from 950 mbar to 1000 mbar.

Altogether, hydrogen is allowed to flow through the thoroughly stirred mixture for 3 h. Nitrogen (about 7000 l/h) is then passed via an immersed tube for 1 h. The reaction mixture is then freed from all volatile constituents at 10 mbar and 140° C. in the course of 1 h.

Working-up by the known methods of industry gives product A (for further characterizations cf. table).

### COMPARATIVE EXAMPLE 1

Deodorization with Hydrogen Under Pressure

At about 90° C., 2.5 kg of palladium on carbon, 1.9 kg of Tonsil and 26 kg of water are added to about 3950 kg of an alkylsiloxane-polyethersiloxane copolymer, prepared analogously to example 5 from EP-B-1 520 870. Thereafter, heating to 150° C. is effected and hydrogen is fed in so that the absolute pressure is about 4 bar. A resultant pressure drop is compensated by repeated adjustment of the excess pressure to 4 bar. Altogether, hydrogenation is effected for 4 h at elevated hydrogen pressure and with thorough mixing. The reaction mixture is brought to atmospheric pressure (prevailing outside pressure) by depressurization and is then freed from all volatile constituents at 4 mbar and 140° C. in the course of 1 h.

Working-up by the known methods of industry gives product B (for further characterizations, cf. table).

### COMPARATIVE EXAMPLE 2

Deodorization with Nitrogen

At about 90° C., 2.5 kg of palladium on carbon, 1.9 kg of Tonsil and 35 kg of water are added to about 3850 kg of an alkylsiloxane-polyethersiloxane copolymer, prepared analogously to example 5 from EP-B-1 520 870. Thereafter, heating to 130° C. is effected and about 7000 l/h of nitrogen are fed in via an immersed tube, the procedure being effected at close to atmospheric pressure, i.e. in a range of from 950 mbar to 1016 mbar.

Altogether, nitrogen is passed through the thoroughly stirred mixture for 3 h. The reaction mixture is then freed from all volatile constituents at 4 mbar and 140° C. in the course of 1 h.

Working-up by the known methods of industry gives product C (for further characterizations, cf. table).

TABLE

| | | | Appearance | | |
|---|---|---|---|---|---|
| | | | & turbidity | | |
| | | | value | | |
| | | | (FTU³) | | Total |
| | | | after | Total | formaldehyde/ |
| | | Appearance | freezing/ | propionaldehyde | acetaldehyde |
| | | (after | heating | content² | content² |
| Product | Example | storage) | cycles¹ | ppm | ppm |
| A | Example 1 | colorless, | 0.753 | <5 (after | <5/<5 |
| | | clear | clear | storage | |
| | | (after | | for 9 | |
| | | storage | | months at | |
| | | for 9 | | RT) | |
| | | months at | | | |
| | | RT) | | | |
| B | Comparative | yellow, | 1.156 | 15 (after | <5/<5 |
| | example 1 | clear | turbid | storage | |
| | | (after | | for 2 | |
| | | storage | | months at | |
| | | for 2 | | RT) | |
| | | months at | | | |
| | | RT) | | | |
| C | Comparative | colorless, | 0.643 | 55 (after | 9/<5 |
| | example 2 | clear | clear | storage | |
| | | (after | | for 1 | |
| | | storage | | month at | |
| | | for 1 | | RT) | |
| | | month at | | | |
| | | RT) | | | |

¹Freezing point: −18° C. and heating temperature: +90° C. (storage for 24 h in each case, three cycles)
²Determination of the total aldehyde content after steam distillation in acidic dilute aqueous solution (apparatus from Buchi K355) and subsequent determination after derivatization with dinitrophenylhydrazine by means of HPLC.
³Turbidity value measured at room temperature using the NEPHLA apparatus from Lange/unit is FTU (Formazin Turbidity Units)

Having thus described in detail various embodiments of the present invention, it is to be understood that the invention defined by the above paragraphs is not to be limited to particular details set forth in the above description as many apparent variations thereof are possible without departing from the spirit or scope of the present invention.

1. A process for the treatment of polyoxyalkylene-polysiloxane block copolymers or alkylpolysiloxane-polyoxyalkylenepolysiloxane block copolymers in which the polysiloxane blocks are bonded to the polyether blocks by SiC bonds,
wherein
the polyoxyalkylene-polysiloxane block copolymers or alkylpolysiloxane-polyoxyalkylenepolysiloxane block copolymers or the solutions thereof are treated with flowing hydrogen gas and optionally a further inert gas,
in the presence of a combination of hydrogenation catalysts and acid-activated carrier materials and water
at temperatures of from 20 to 200° C. and atmospheric pressure over a period of from 0.5 to 10 hours.

2. The process as claimed in claim 1, wherein hydrogen is allowed to act at temperatures of from 110 to 140° C.

3. The process as claimed in claim 1, wherein the catalysts used are heavy metal catalysts for hydrogenation reactions.

4. The process as claimed in claim 3, wherein Ni, Cu, Cr or metals of the platinum group are used in an amount of from 0.00001 to 1% by weight of metal, based on polyethersiloxane, as a hydrogenation catalyst.

5. The process as claimed in claim 1, wherein amounts in the range of from 0.01 to 0.1% by weight, based on polyethersiloxane, of an acidic alumina are used as acid-activated carrier materials.

6. The process as claimed in claim 1, which is carried out in the presence of water in an amount in the range of from 0.1 to 5% by weight, based on polyethersiloxane.

7. The process of claim 2, wherein
amounts in the range of from 0.025 to 0.08% by weight, based on polyethersiloxane, of an acidic alumina are used as acid-activated carrier materials, and
is carried out in the presence of water in an amount in the range of from 0.1 to 3% by weight.

8. The process of claim 7, wherein
amounts in the range of from 0.04 to 0.06% by weight, based on polyethersiloxane, of an acidic alumina are used as acid-activated carrier materials, and
is carried out in the presence of water in an amount in the range of from 0.1 to 2% by weight.

9. The process as claimed in claim 1, which is carried out in the presence of from 0.1 to 1% by weight of an aqueous buffer solution having a pH of from 3 to 6.

10. The process as claimed in claim 8, which is carried out in the presence of from 0.1 to 1% by weight of an aqueous buffer solution having a pH of from 3 to 6.

11. The process as claimed in claim 10, wherein Ni, Cu, Cr or metals of the platinum group are used in an amount of from 0.00001 to 1% by weight of metal, based on polyethersiloxane, as a hydrogenation catalyst.

12. The process as claimed in claim 1, wherein the polyalkylene-polysiloxane block copolymers or alkylpolysiloxane-polyalkylenepolysiloxane block copolymers correspond to the general formula 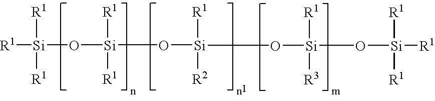
in which the substitutents and indices have the following meaning:
R¹=alkyl radical, and/or aromatic radical and/or R³,
R²=alkyl radical having 2 to 20 carbon atoms,
R³=—(CH₂)₃—O—(C₂H₄O)ₓ—(C₃H₆O)_{y}—R⁴,
R⁴=hydrogen or alkyl radical having 1 to 4 carbon atoms,
n=from 0 to 150,
n¹=from 0 to 50,
m=from 0 to 50,
x=from 1 to 30,
y=from 0 to 30,
with the proviso that at least one radical has the meaning R³ in the molecule.

13. The process of claim 12, wherein:
R¹=methyl
n=from −1 to 120,
n¹=from 0 to 40,
m=from 1 to 40,
x=from 1 to 25, and
y=from 0 to 25.
